(19) United States
(12) Patent Application Publication
(10) Pub. No.: US 2007/0020363 A1
(43) Pub. Date: Jan. 25, 2007

(54) Ice cream cone shell

(76) Inventor: David Hansen, Manchester, CT (US)

Correspondence Address: THE LAW OFFICES OF STEVEN MCHUGH, LLC, 46 WASHINGTON STREET, MIDDLETOWN, CT, 06457, US

(21) Appl. No.: 11/185,618

(22) Filed: Jul. 19, 2005

(51) Int. Cl. A21D 13/00

(52) U.S. Cl. 426/138

(57) ABSTRACT

For an ice cream cone shell defining a cone cavity and including a shell top portion communicated with a shell bottom portion via the cone cavity, wherein the shell bottom portion includes a cone bottom opening, a method for improving the ice cream cone shell is provided, wherein the method includes introducing a plugging substance into the cone cavity, such that the plugging substance is associated with the shell bottom portion and processing the plugging substance to cover at least a portion of the cone bottom opening to at least partially enclose the shell bottom portion of the cone cavity.

### FIELD OF THE INVENTION

This disclosure relates generally to ice cream cones, and more specifically to a method for improving an ice cream cone shell.

### BACKGROUND OF THE INVENTION

For over a century, Americans have been enjoying ice cream on a cone. Whether in the form of a waffle, sugar or wafer cone, the ice cream cone offers a delicious means of containing and enjoying ice cream. As the modern ice cream cone has developed, two popularly distinct types of cones have emerged. They are the rolled cone and the molded cone. The rolled cone is typically a waffle sheet baked and rolled into a conical shape (in earlier years by hand, later mechanically) as soon as it comes off the griddle, where after a few seconds, the rolled waffle sheet hardens into the form of a cone. On the other hand, the molded cone may be formed either by introducing cone batter into a shaped mold, inserting a core mold into the batter, baking the batter and then removing the core mold, wherein baking the batter with the core mold in place produces a cone cavity for containing ice cream, or by pouring the batter into a shaped mold, baking the batter and then splitting the mold so the cone can be removed. In the 1920s, as ice cream cones grew in popularity the cone business expanded and changes in automatic machinery led to the ice cream cones we know today. In fact, currently millions of cones are turned out on machines that are capable of producing about 150,000 cones every 24 hours.

Unfortunately however, even though the rolled cone remains popular, when compared with the molded cone, the rolled cone includes at least one disadvantage: ice cream containment. This is because as the cone sheet is rolled during the cone development process, the resultant rolled cone includes a hole at the base of the cone, as shown in FIG. 1, allowing for melting ice cream to leak through. Thus, as the ice cream cone is eaten and the ice cream melts, the melted ice cream within the cone leaks from the bottom of the cone. Currently, several methods have been devised to contain the ice cream within the rolled cone. One such method involves wrapping the bottom of the cone with paper or napkins to absorb the ice cream leaking from the bottom. However, because paper products are typically porous, they can become saturated with the leaking substance allowing the ice cream to drip onto the consumer.

Although attempts to prevent the cone from becoming soggy have been devised, most attempts have been to prevent the cone from becoming saturated by melting ice cream. For example, U.S. Pat. No. 6,235,329 to Grigoli, et al. (May 22, 2001) discloses inserting a preformed conical chocolate shell into the cavity of a cone. However, this shell is not meant to prevent melting ice cream from leaking out of the cone, but rather to allow the cone to remain crispy by preventing the cone itself from becoming saturated by the melting ice cream resulting in a soggy cone. Because the shells are preformed they tend to be of uniform width and are thus subject to breaking and cracking during shipping. As such, the melting ice cream would tend to leak out of the cracks. Additionally, these shells are typically not sized for specific cones so the shell would probably end up being larger or smaller than the cone being used and as such, would either extend beyond or below the cone walls making eating the cone a cumbersome and potentially messy task. Furthermore, during the consumption of an ice cream cone having a shell, the biting process would tend to cause a pressure on the shell within the cone cavity causing the shell to break into little pieces. As such, this type of shell can not be used to prevent fluid substances from leaking out of the bottom of the cone.

### SUMMARY OF THE INVENTION

For an ice cream cone shell defining a cone cavity and including a shell top portion communicated with a shell bottom portion via the cone cavity, wherein the shell bottom portion includes a cone bottom opening, a method for improving the ice cream cone shell is provided, wherein the method includes introducing a plugging substance into the cone cavity, such that the plugging substance is associated with the shell bottom portion and processing the plugging substance to cover at least a portion of the cone bottom opening to at least partially enclose the shell bottom portion of the cone cavity.

For an ice cream cone shell defining a cone cavity and including a shell top portion communicated with a shell bottom portion via the cone cavity, wherein the shell bottom portion includes a cone bottom opening, a method for improving the ice cream cone shell is provided, wherein the method includes introducing a plugging substance into the cone cavity and processing the plugging substance to pluggingly associate the plugging substance with at least a portion of the cone bottom opening.

An improved ice cream cone shell is provided, wherein the improved ice cream cone shell includes an ice cream cone shell defining a cone cavity, wherein the ice cream cone shell includes a shell top portion communicated with a shell bottom portion via the cone cavity, wherein the shell bottom portion includes a cone bottom opening communicated with the cone cavity and a plugging substance, wherein the plugging substance is disposed within the cone cavity to be pluggingly associated with the cone bottom opening.

### BRIEF DESCRIPTION OF THE DRAWINGS

The foregoing and other features and advantages of the present invention should be more fully understood from the following detailed description of illustrative embodiments taken in conjunction with the accompanying Figures in which like elements are numbered alike in the several Figures:

FIG. 1 is a front view of an ice cream cone in accordance with the prior art;

FIG. 2 is a front view of an improved ice cream cone shell in accordance with an exemplary embodiment;

FIG. 3 is a top down view of the improved ice cream cone shell of FIG. 2;

FIG. 4 is a front view of an ice cream cone using the improved ice cream cone shell in FIG. 2;

FIG. 5 is a sectional front view of an ice cream cone using the improved ice cream cone shell in FIG. 2;

FIG. 6 is a block diagram illustrating a method for improving an ice cream cone shell;

FIG. 7 is a sectional front view of the improved ice cream cone shell in FIG. 2, in accordance with a first embodiment;

FIG. 8 is a sectional front view of the improved ice cream cone shell in FIG. 2, in accordance with a first embodiment;

FIG. 9 is a sectional front view of the improved ice cream cone shell in FIG. 2, in accordance with a first embodiment;

FIG. 10 is a sectional front view of the improved ice cream cone shell in FIG. 2, in accordance with a second embodiment;

FIG. 11 is a sectional front view of the improved ice cream cone shell in FIG. 2, in accordance with a second embodiment;

FIG. 12 is a sectional front view of the improved ice cream cone shell in FIG. 2, in accordance with a third embodiment;

FIG. 13 is a sectional front view of the improved ice cream cone shell in FIG. 2, in accordance with a third embodiment; and

FIG. 14 is a sectional front view of the improved ice cream cone shell in FIG. 2, in accordance with a third embodiment.

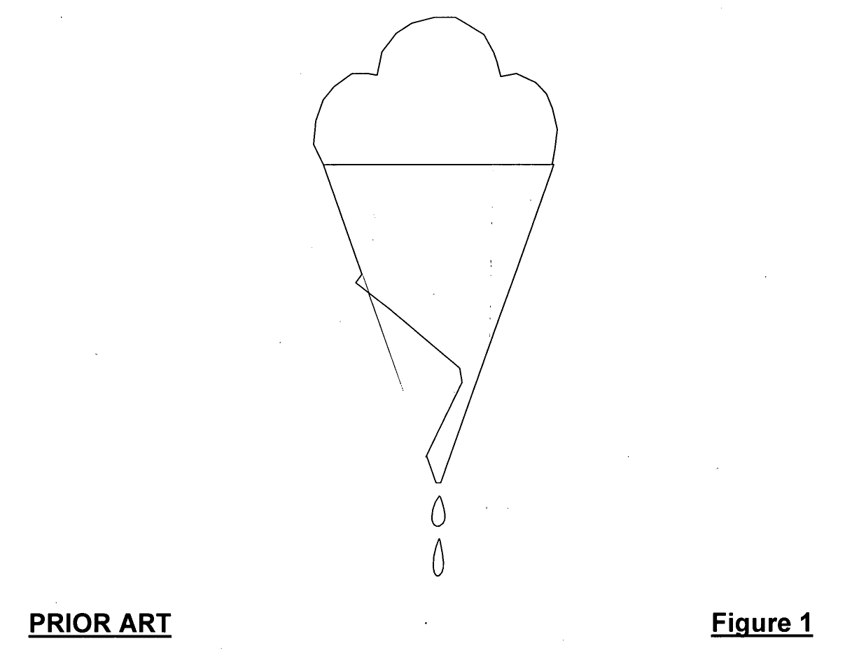

### DETAILED DESCRIPTION

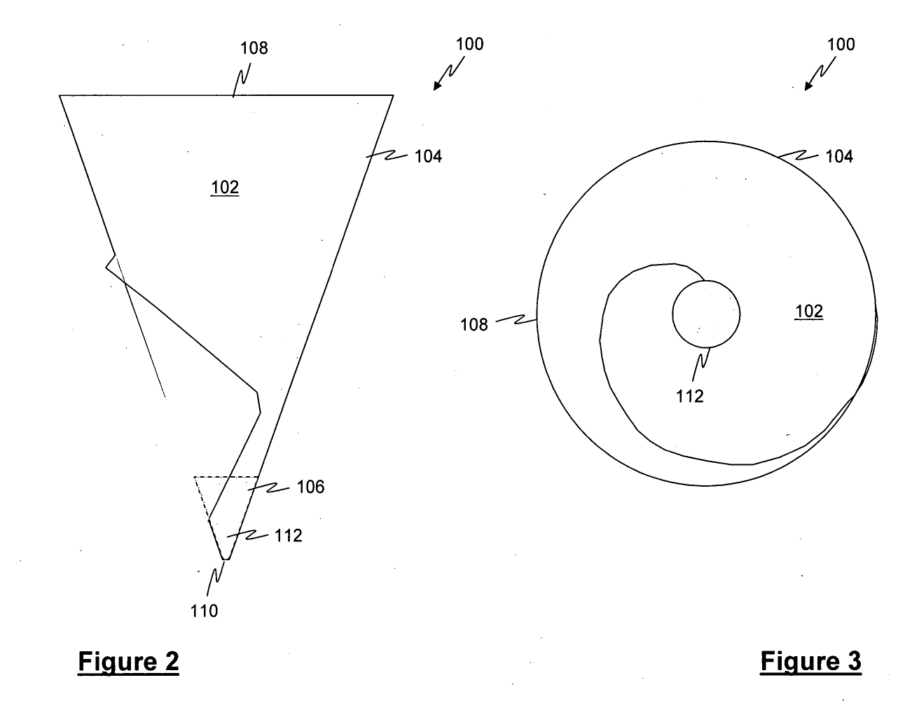

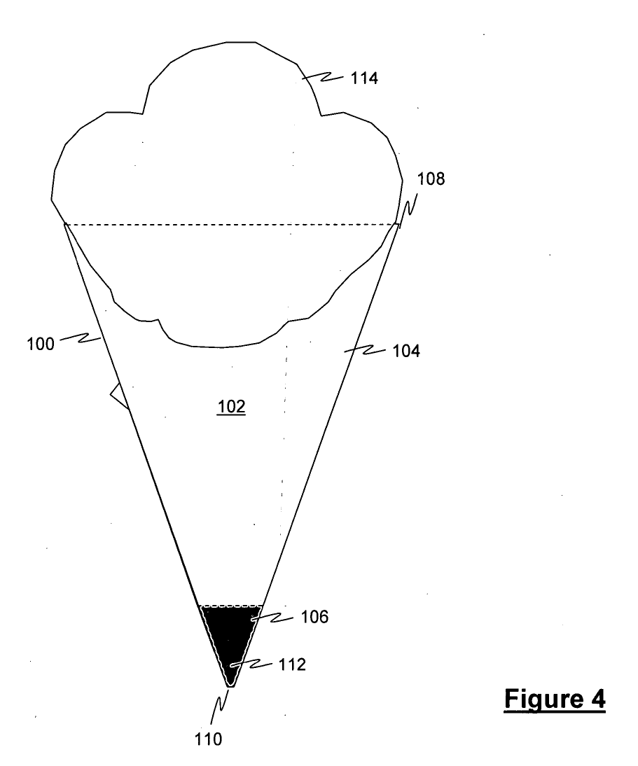

Referring to FIG. 2 and FIG. 3, one embodiment of an improved ice cream cone shell 100 is illustrated, wherein the ice cream cone shell 100 defines a cone cavity 102 and includes a shell top portion 104 communicated with a shell bottom portion 106 via the cone cavity 102. The shell top portion 104 includes a cone top opening 108 for supportingly containing a portion of ice cream and the shell bottom portion 106 includes a cone bottom opening 110. The improved ice cream cone shell 100 includes a sealing material 112 disposed within the cone cavity 102 to be sealingly and blockingly associated with the cone bottom opening 110.

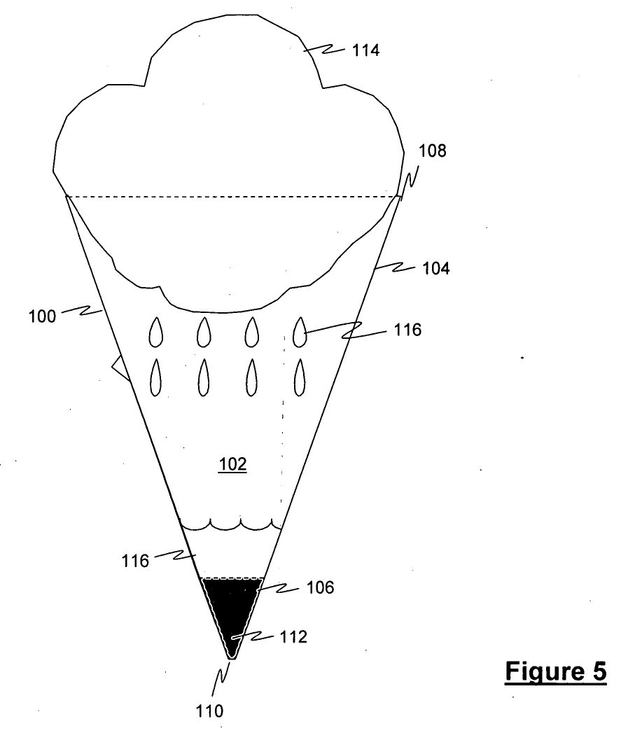

Referring to FIG. 4, a portion of ice cream 114 is shown associated with the cone top opening 108 of the ice cream cone shell 100 to be at least partially disposed within the cone cavity 102. Referring to FIG. 5, as the portion of ice cream 114 begins to melt, a melted portion of ice cream 116 drips from the portion ice cream 114 to traverse the cone cavity 102 and settle in the shell bottom portion 106 to be disposed on top of sealing material 112. Because the sealing material 112 is sealingly and blockingly associated with the cone bottom opening 110, the sealing material 112 blocks the cone bottom opening 110 causing the melted portion of ice cream 116 to be contained within the cone cavity 102.

It should be appreciated that the sealing material 112 may be any edible material capable of sealingly enclosing the cone bottom opening 110, such as a solid chocolate, a viscous chocolate, a solid honey and a viscous honey. Additionally, the sealing material 112 may be any edible liquid substance capable of solidifying via any catalyst, such as temperature and or additive and may include, but not be limited to chocolate, honey, white chocolate, marshmallow, sugar and any other substances suitable to the desired end purpose of plugging the bottom end opening.

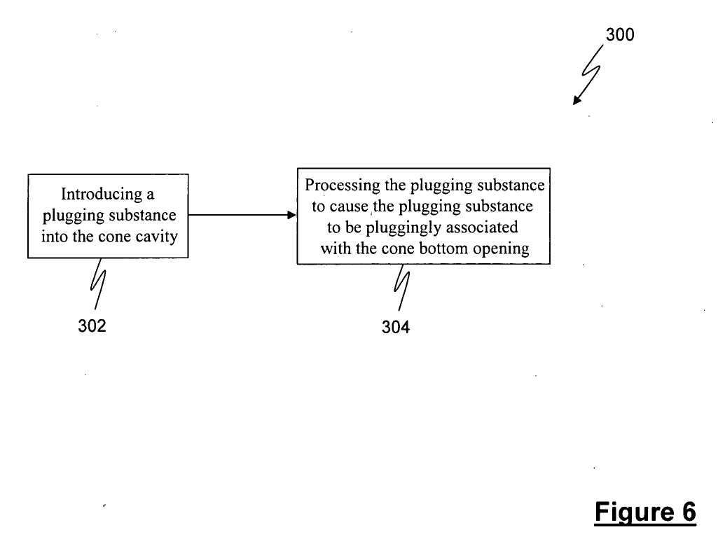

Referring to FIG. 6, for an ice cream cone shell defining a cone cavity and including a shell top portion communicated with a shell bottom portion via the cone cavity, wherein the shell bottom portion includes a cone bottom opening, a method 300 for improving the ice cream cone shell is provided, wherein the method includes introducing a plugging substance or sealing material 112 into the cone cavity 102, as shown in operational block 302. This may be accomplished in a number of ways that may be dependent upon the physical state of the sealing material 112. For example, if the sealing material 112 is in a fluid state, then the sealing material may be poured into the cone cavity 102 to fill the shell bottom portion 106 of the cone cavity 102. If desired, then an ‘initial’ plugging material 113 may be used to temporarily cover the cone bottom opening 110 until the sealing material 112 is processed. This ‘initial’ plugging material 113 may be an edible, malleable material such as chocolate and chewing gum that is capable of temporarily plugging the cone bottom opening 110 until the sealing material 112 is processed. On the other hand, if the sealing material 112 is in a solid state, such as chunks of chocolate 115, then the sealing material 112 may simply be disposed within the cone cavity 102.

The method 300 for improving the ice cream cone shell 100 further includes processing the sealing material 112 to cover at least a portion of the cone bottom opening 110 such that the shell bottom portion 106 is at least partially enclosed, as shown in operational block 304. As above, this may be accomplished in a manner dependent upon the physical state of the sealing material 112. For example, if the sealing material 112 is in a fluid or a partially fluid physical state when introduced into the cone cavity, then processing may include adding a catalytic agent to the sealing material 112 and/or exposing the sealing the material 112 to a first predetermined temperature range to create an edible sealing material 112 that either does not flow at all or that flows very, very slowly, such as a fluid having a high viscosity and/or a fluid that is at least partially solidified.

On the other hand, if the sealing material 112 is disposed in a solid or partially solid physical state when it is introduced into the cone cavity 102, then processing may include exposing the sealing material 112 to a second predetermined temperature range to create a sealing material 112 which settles in the shell bottom portion 106 of the cone cavity 102 to at least partially cover the cone bottom opening 110. In this case, depending upon the sealing material 112 used, an additional action may be desired to create an edible sealing material 112 that either does not flow at all or that flows very, very slowly, such as a fluid having a high viscosity and/or a fluid that is at least partially solidified. This additional action may include adding a catalytic agent to the sealing material 112 and/or exposing the sealing the material 112 to a first predetermined temperature range.

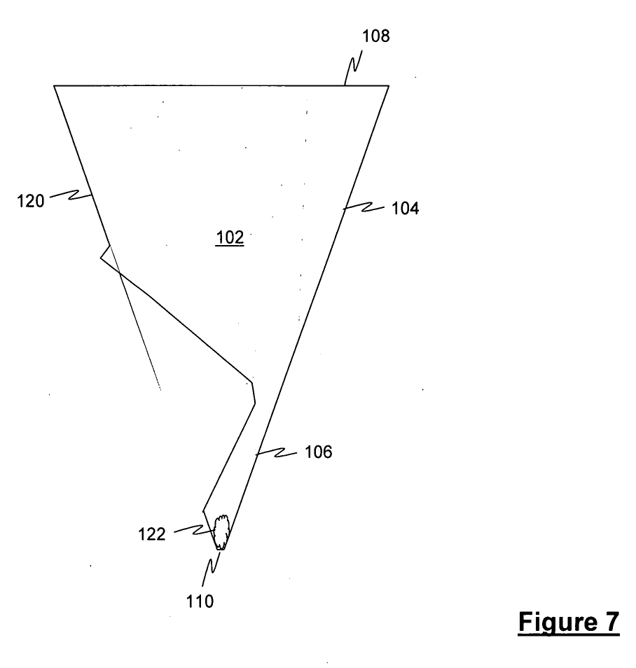

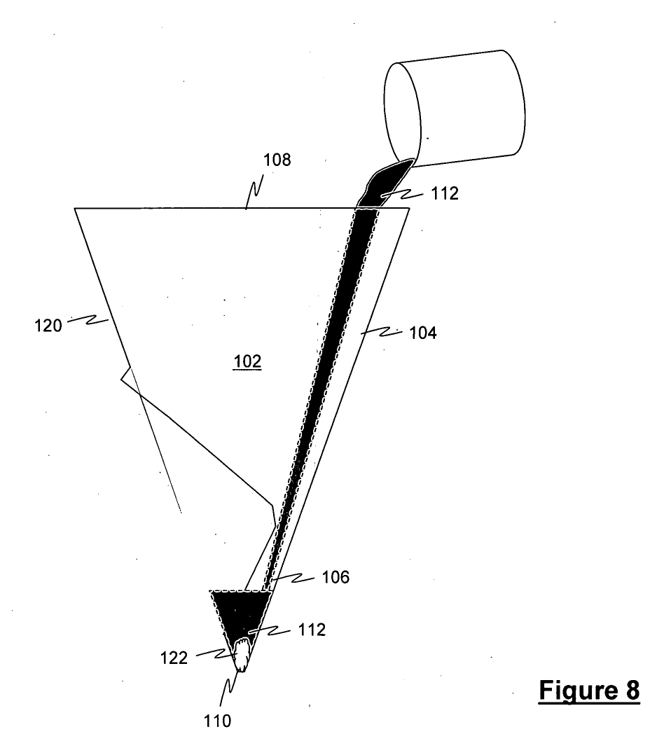

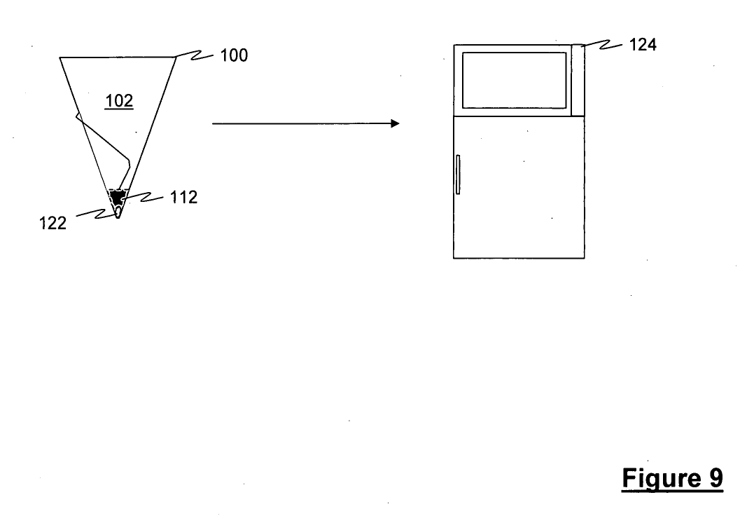

Referring to FIG. 7 and FIG. 8, one embodiment for accomplishing the method 300 for improving the ice cream cone shell 120 is discussed, wherein the method includes introducing a plugging substance or sealing material 112 into the cone cavity 102, as shown in operational block 302. In this embodiment, the sealing material 112 is a liquid sealing material 112 having a low viscosity, such as melted chocolate, and thus has a tendency to flow easily. If desired, to minimize leakage of the sealing material 112 out of the cone bottom opening 110, an edible, malleable sealing material 112 such as soft chocolate 122 is disposed within the cone cavity 102 and compressed to temporarily cover the cone bottom opening 110. The liquid sealing material 112 is poured into the cone cavity 112 to fill the shell bottom portion 106 of the cone cavity 102. Referring to FIG. 9, once the liquid sealing material 112 has been introduced into the cone cavity 102, the ice cream cone shell 120 containing the sealing material 112 may be processed, as shown in operational block 304. This may be accomplished by disposing the ice cream cone shell 120 containing the sealing material 112 into a low temperature environment, such as a refrigerator 124. This allows the sealing material 112 to become thicker thus increasing its resistance to flow resulting in the blockage of the cone bottom opening 110.

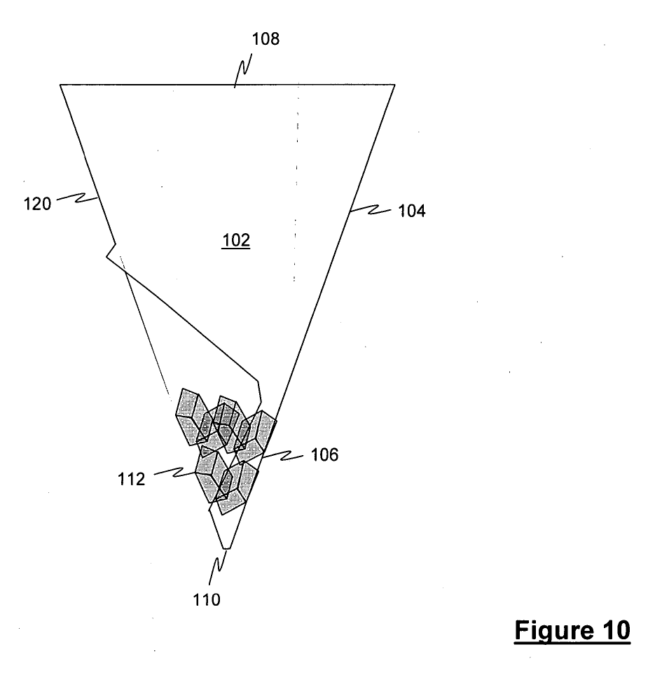

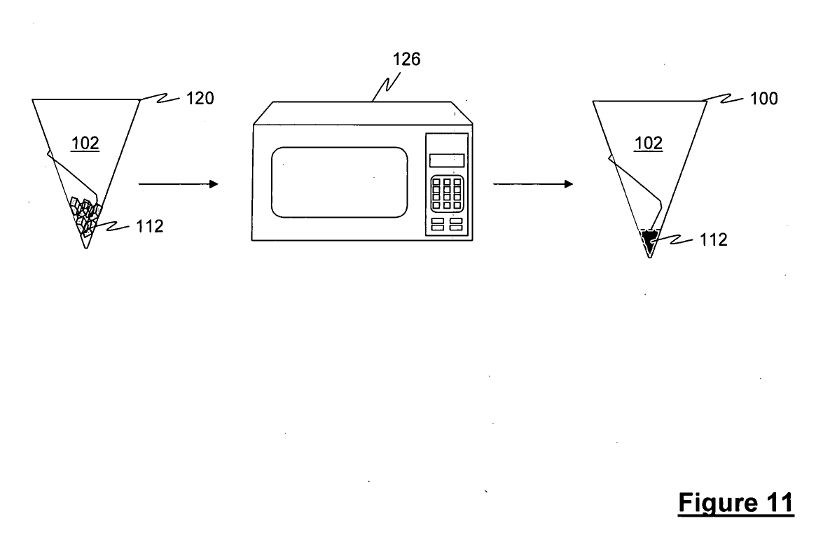

Referring to FIG. 10, an additional embodiment for accomplishing the method 300 for improving the ice cream cone shell 120 is discussed, wherein the method includes introducing a plugging substance or sealing material 112 into the cone cavity 102, as shown in operational block 302. In this embodiment, the sealing material 112 is a solid sealing material 112, such as solid pieces of chocolate. The solid sealing material 112 is disposed within the cone cavity 112 to be associated with the shell bottom portion 106 of the cone cavity 102. Referring to FIG. 11, once the solid sealing material 112 has been introduced into the cone cavity 102, the ice cream cone shell 120 containing the sealing material 112 may be processed, as shown in operational block 304. This may be accomplished by disposing the ice cream cone shell 120 containing the sealing material 112 into a high temperature environment, by increasing the temperature of the sealing material 112, such as a microwave oven 126, or by introducing a catalyst to the sealing material 112. This may allow the sealing material 112 to at least partially change physical state allowing the sealing material 112 to flow toward the cone bottom opening 110. Once the sealing material has stopped flowing and depending upon the sealing material 112 used, the ice cream cone shell 120 may be exposed at room temperature, the ice cream cone shell 120 may be exposed to a low temperature environment to or a catalyst may be added to the sealing material 112 to allow the sealing material 112 to become resistant to flow thus resulting in the blockage of the cone bottom opening 110.

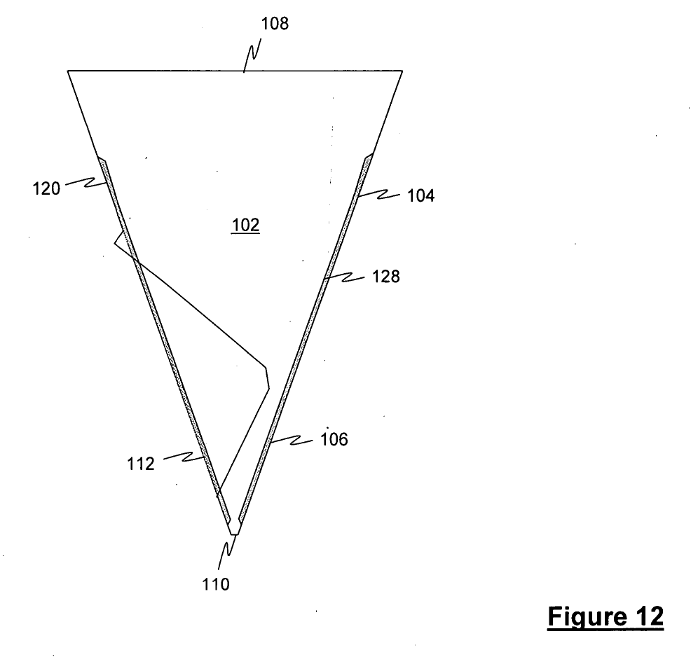

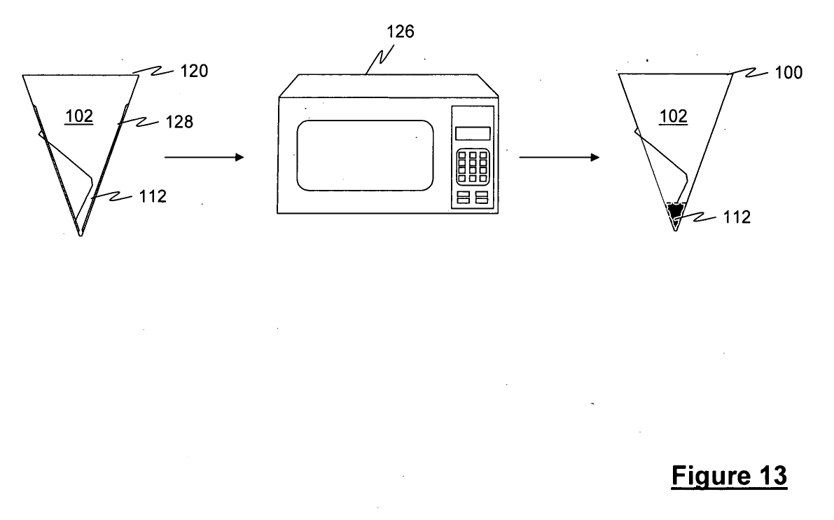

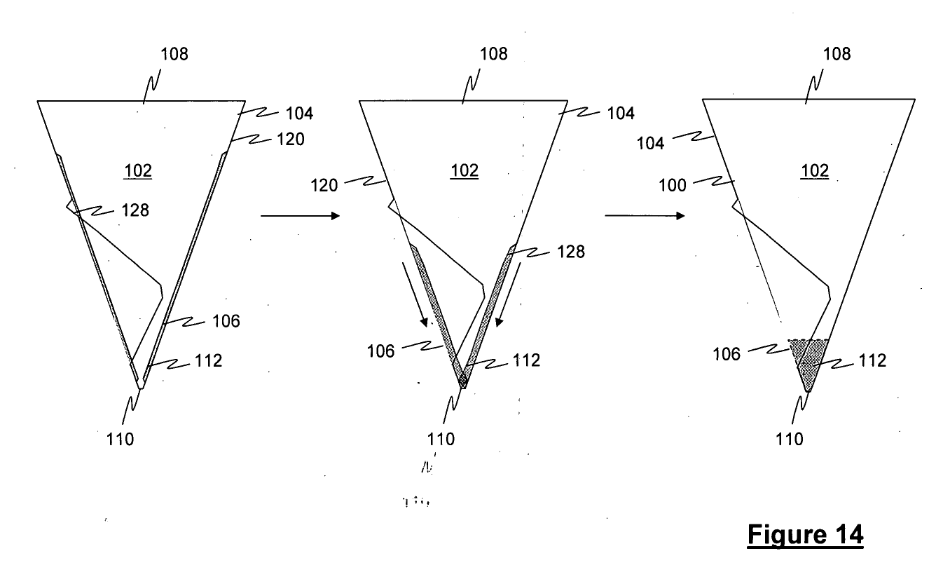

Referring to FIG. 12, an additional embodiment for accomplishing the method 300 for improving the ice cream cone shell 120 is discussed, wherein the method includes introducing a plugging substance or sealing material 112 into the cone cavity 102, as shown in operational block 302. In this embodiment, the sealing material 112 is a solid sealing material 112, such as a chocolate covering 128 disposed along the inside wall of the ice cream cone shell 120. Referring to FIG. 13 and FIG. 14, once the solid sealing material 112 has been introduced into the cone cavity 102, the ice cream cone shell 120 containing the sealing material 112 may be processed, as shown in operational block 304. This may be accomplished by disposing the ice cream cone shell 120 containing the sealing material 112 into a high temperature environment, by increasing the temperature of the sealing material 112, such as a microwave oven 126 to cause the sealing material 112 to at least partially change physical state allowing the sealing material 112 to flow toward the cone bottom opening 110. Once the sealing material has stopped flowing and depending upon the sealing material 112 used, the ice cream cone shell 120 may be exposed at room temperature, the ice cream cone shell 120 may be exposed to a low temperature environment to or a catalyst may be added to the sealing material 112 to allow the sealing material 112 to become resistant to flow thus resulting in the blockage of the cone bottom opening 110.

It should be appreciated that the sealing material 112 may be any type of sealing material, edible or non-edible, capable of being configured to substantially reduce the rate of flow of melted ice cream from the cone bottom opening 110 suitable to the desired end purpose, such as chocolate, honey, molasses and candy.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed:

1. For an ice cream cone shell defining a cone cavity and including a shell top portion communicated with a shell bottom portion via the cone cavity, wherein the shell bottom portion includes a cone bottom opening, a method for improving the ice cream cone shell, the method comprising:
introducing a plugging substance into the cone cavity, such that the plugging substance is associated with the shell bottom portion; and
processing said plugging substance to cover at least a portion of the cone bottom opening to at least partially enclose the shell bottom portion of the cone cavity.

2. The-method of claim 1, wherein said introducing includes disposing said plugging substance within the cone cavity such that the plugging substance is associated with the shell bottom portion to at least partially cover the cone bottom opening.

3. The method of claim 2, wherein said processing includes processing said plugging substance to cause said plugging substance to at least partially assume the shape of the shell bottom portion of the cone cavity to at least partially enclose the shell bottom portion of the cone cavity by covering at least a portion of the cone bottom opening.

4. The method of claim 1, wherein said plugging substance includes a resistance to flow, wherein said resistance to flow includes a first resistance to flow and a second resistance to flow and wherein said resistance to flow is configurable between said first resistance to flow and said second resistance to flow.

5. The method of claim 4, wherein said processing includes processing said plugging substance to configure said resistance to flow between said first resistance to flow and said second resistance to flow.

6. The method of claim 1, wherein said plugging substance is an edible substance and includes at least one of solid chocolate, liquid chocolate, solid honey, liquid honey, marshmallow, sugar and any combination thereof

7. The method of claim 1, wherein said introducing includes introducing said plugging substance into the cone cavity such that the plugging substance is associated with at least a portion of the wall of the cone cavity.

8. The method of claim 7, wherein said processing includes processing said plugging substance such that said plugging substance becomes disassociated from said wall of the cone cavity and such that the plugging substance becomes associated with the shell bottom portion to at least partially cover the cone bottom opening.

9. The method of claim 1, wherein said introducing includes introducing said plugging substance as a fluid substance and wherein said processing includes exposing said plugging substance to a predetermined temperature range to cause said plugging substance to become resistant to flow.

10. The method of claim 9, wherein said predetermined temperature is at least one of a room temperature, a freezer temperature and a refrigerator temperature.

11. The method of claim 1, wherein the ice cream cone shell is at least one of a waffle cone, a sugar cone, a wafer cone and any combination thereof.

12. The method of claim 1, wherein said processing includes at least one of exposing said plugging substance to a low temperature environment, exposing said plugging substance to a room temperature environment, exposing said plugging substance to a high temperature environment, exposing said plugging substance to a microwave field, introducing a catalyst to said plugging substance and any combination thereof.

13. For an ice cream cone shell defining a cone cavity and including a shell top portion communicated with a shell bottom portion via the cone cavity, wherein the shell bottom portion includes a cone bottom opening, a method for improving the ice cream cone shell, the method comprising:
introducing a plugging substance into the cone cavity; and
processing said plugging substance to cause said plugging substance to be pluggingly associated with the cone bottom opening.

14. The method of claim 1, wherein said introducing includes disposing said plugging substance within the cone cavity such that the plugging substance is associated with the shell bottom portion to at least partially cover the cone bottom opening.

15. The method of claim 14, wherein said processing includes processing said plugging substance to cause said plugging substance to at least partially assume the shape of the shell bottom portion of the cone cavity to at least partially enclose the shell bottom portion of the cone cavity by covering at least a portion of the cone bottom opening.

16. The method of claim 13, wherein said plugging substance includes a resistance to flow, wherein said resistance to flow includes a first resistance to flow and a second resistance to flow and wherein said resistance to flow is configurable between said first resistance to flow and said second resistance to flow.

17. The method of claim 16, wherein said processing includes processing said plugging substance to configure said resistance to flow between said first resistance to flow and said second resistance to flow.

18. The method of claim 13, wherein said processing includes at least one of exposing said plugging substance to a low temperature environment, exposing said plugging substance to a room temperature environment, exposing said plugging substance to a high temperature environment, exposing said plugging substance to a microwave field, introducing a catalyst to said plugging substance and any combination thereof.

19. An improved ice cream cone shell comprising:
an ice cream cone shell defining a cone cavity, wherein said ice cream cone shell includes a shell top portion communicated with a shell bottom portion via said cone cavity, wherein said shell bottom portion includes a cone bottom opening communicated with said cone cavity; and
a plugging substance, wherein said plugging substance is disposed within said cone cavity to be pluggingly associated with said cone bottom opening. 20. The improved ice cream cone shell of claim 19, wherein said plugging substance includes at least one of chocolate, white chocolate, honey, marshmallow, sugar and any combination thereof and wherein said ice cream cone shell includes at least one of a waffle cone, a sugar cone and a wafer cone.
